(19) United States
(12) Patent Application Publication
(10) Pub. No.: US 2008/0201774 A1
(43) Pub. Date: Aug. 21, 2008

(54) Security System

(75) Inventor: Francis Ormond Bruce, Neutral Bay (AU)

Correspondence Address: OSTROLENK FABER GERB & SOFFEN, 1180 AVENUE OF THE AMERICAS, NEW YORK, NY, 100368403, US

(73) Assignee: BIOMETRIC SYSTEMS INTERNATIONAL PTY LTD, North Sydney (AU)

(21) Appl. No.: 11/571,888

(22) PCT Filed: Jul. 11, 2005
(86) PCT No.: PCT/AU2005/001014

§ 371 Date: Dec. 18, 2007

(30) Foreign Application Priority Data
Jul. 12, 2004 (AU) 2004903813

(51) Int. Cl. G06F 7/04; A63F 9/24

(52) U.S. Cl. 726/19

(57) ABSTRACT

A security system for controlling access to a plurality of secure areas, an interface to obtain verification data, particularly biometric scan data of the user, processing means arranged to compare the biometric scan data with stored template data and return a match condition, and signal means arranged to allow access to at least one of the plurality of secure areas if the match condition is satisfied.

### CROSS REFERENCE TO RELATED APPLICATION

The present application is a 35 U.S.C. §§ 371 national phase conversion of PCT/AU2005/001014, filed Jul. 11, 2005, which claims priority from Australian Patent Application No. 2004903813, filed Jul. 12, 2004, the contents of which are herein incorporated by reference. The PCT International Application was published in English.

### FIELD OF THE INVENTION

The present invention relates to a security system for controlling access to a plurality of secure areas. The invention has been developed especially, but not exclusively, for controlling access to poker machines and the invention is herein described in that context. It is to be appreciated, however, that the invention has broader application is not limited to that use.

### BACKGROUND OF THE INVENTION

The total number of operational poker machines has grown exponentially over the last few years. Nowadays, it is not unusual for many casinos or private clubs to have upward of three hundred poker machines. As the operation of poker machines is governed by legislation and other forms of government regulation, there is a strong onus on poker machine owners and operators to strictly control and monitor access to the interior of each poker machine, to prevent theft and tampering. At a practical level, however, staff of the casino or club must routinely access each of the poker machines for a variety of reasons, such as removing money jams, clearing daily takings and general maintenance.

In casinos and clubs where there are a large number of poker machines, there is a correspondingly large group of employees who are authorised to access the poker machines. Where there are a large number of employees who have access to each poker machine, there is little accountability and no clear audit trail to determine which employee has been accessing each poker machine. When discrepancies in takings or tampering occurs, it may be difficult to determine which employee last accessed the poker machine.

Moreover, every poker machine at a venue is keyed to a common key set so, the loss or theft of any key set requires that all poker machines at the venue have their locks changed and new key sets created to maintain security. This is a costly and laborious process.

Furthermore, individually opening all poker machines for cash clearance is a laborious and time consuming task and creates a security exposure for the duration of the clearing. A faster cash clearance reduces the security risk.

### SUMMARY OF THE INVENTION

In a first aspect, the present invention provides a security system for controlling access to a plurality of secure areas comprising:

an interface to obtain biometric scan data of a user;

processing means arranged to compare the biometric scan data with stored template data and return a match condition; and

signal means arranged to allow access to at least one of the plurality of secure areas if the match condition is satisfied.

In one form, each one of the plurality of secure areas corresponds to at least one secure area in each of a plurality of poker machines.

In a further aspect, the present invention provides a security system for controlling access to at least one secure area in each of a plurality of poker machines comprising:

an interface to obtain verification data of a user;

processing means configured to communicate with the interface and compare the verification data with a stored template to return a match condition; and

signal means arranged to allow access to the at least one secure area in at least one of the plurality of poker machines if the match condition is satisfied. In a particular form, the verification data is biometric scan data.

In one form, the security system further comprises an interface to allow a user to enter data nominating at least one of the plurality of secure areas and wherein the signal means is arranged to allow access to these nominated secure areas if the match condition is satisfied.

The biometric scan data and the secure area nominating data may be transmitted as a single string of data to the processing means.

The first interface may be arranged to allow the user to additionally enter a personal identification code to further identify the user.

The single string of data may be transmitted in the form of a wiegand string. The data may also be encrypted.

The computing system may further include a database arranged to store template data. When template data is stored in the database, the personal identification data of the user may be replicated and associated with each secure area to create a unique id record for each combination of the user identification data and secure area nomination data.

The processing means may further include logging means arranged to store, in the database, a record of each attempted or successful access to each secure area.

The biometric scan data may be finger scan data.

The signal means may send a signal via a network to a lock which is arranged to release on receipt of the signal, thereby allowing a user to gain access to the secure area.

The lock may be released by actuation of a motor in communication with the lock.

The network may further include a striker board, the striker board being arranged to selectively control at least one of a plurality of locks.

The striker board may send a return signal to the controller to indicate that at least one of the plurality of locks has been released.

The striker board may selectively control a lock on receipt of a plurality of signals. The signal means may include an opening delay means, to vary the time interval that passes before the signal is sent to the lock.

The processing means may include a time delay means, wherein a lock is only released if the request by a user is made during a predetermined time period.

The processing means may also include a cancellation means, wherein a request to release a lock is cancelled if the cancellation means sends a cancellation signal to the lock.

Each one of the plurality of secure areas may correspond to the internal space of a plurality of poker machines. The plurality of secure areas may include at least one of a plurality of sections within the internal space of one poker machine.

### DETAILED DESCRIPTION OF THE DRAWINGS

Notwithstanding any other forms which may fall within the scope of the present invention, an embodiment of the invention will now be described, by way of example only, with reference to the accompanying drawings in which:

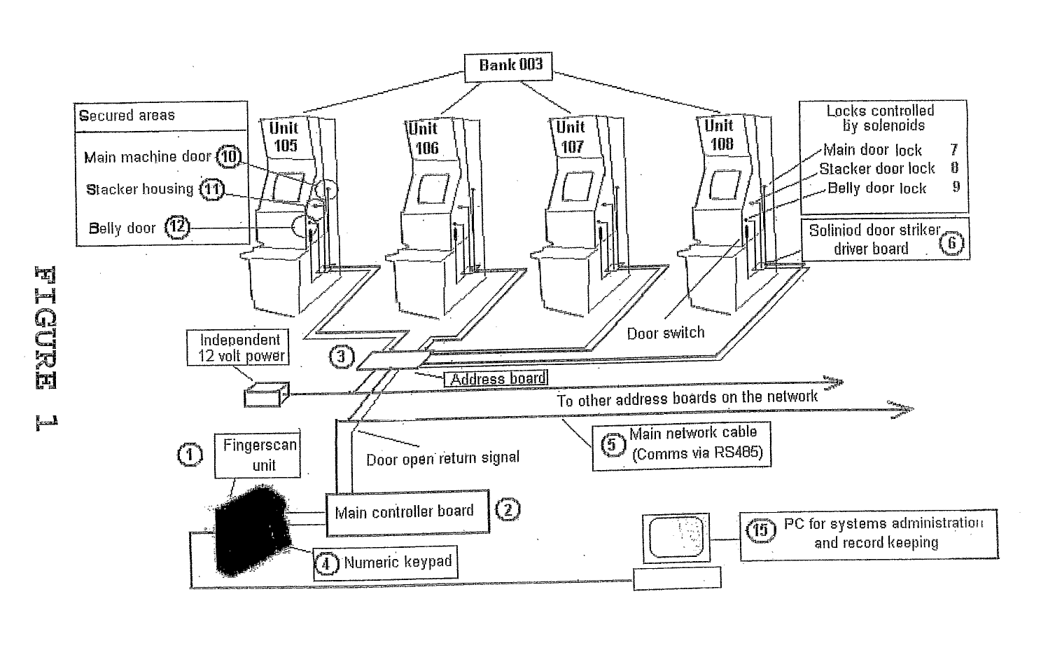

FIG. 1 is a block diagram depicting a system in accordance with an embodiment of the present invention.

### DESCRIPTION OF A SPECIFIC EMBODIMENT

Referring to FIG. 1, there is shown a block diagram representing a system in accordance with an embodiment of the present invention. The system includes a central controller 2, which is interfaced with a finger scanning unit 1 and an input device 4. In the embodiment described herein, the input device is a numeric keypad, although it will be understood that other input devices may be used, such as a touch responsive LCD (liquid crystal display) screen, a keyboard, or any other suitable input device.

The central controller 2 is connected via a network 5 to a plurality of addressing controller boards 3. The addressing controller boards preferably reduce the amount of cabling required to and from the finger scanning unit 1. This provides the dual advantage of reducing cabling costs and allowing all machines to be controlled from a single finger scanning unit. The addressing controller board 3 connects to a plurality of striker boards 6 which in turn control locks 7,8,9, each lock being associated with a different secure section 10, 11, 12 within each secure area, which in this example is poker machines 105, 106, 107, 108. In the present example, the secure section is a section within each poker machine, and the lock is mounted on a door that, when in a closed position, prevents access to the internal area of the poker machine and/or the money stacker box housing.

The locks 7,8,9 are releasable on receiving an appropriate signal from the central controller 2 via the addressing board 3 and striker board 6. When the lock is released, a user may access the corresponding secure area of each of the poker machines 105, 106, 107, 108. It will be understood that the striker boards 6 may be designed to only release the lock on receipt of a plurality of signals. For example, in many poker machines, there is provided an outer “service” door, and an inner cash box door. The striker board 6 may be associated with a lock on the inner “cash box” door, and may be arranged to only open on receipt of a signal from the addressing board 3, and on a signal from the service door, to indicate that the service door has been opened.

The striker board 6 may include further functionality, including the ability to wait a predetermined amount of time before revoking a previous command to open if the user has not opened the outer door, the ability to send a signal back to the addressing board signifying that the machine access door has been opened and the ability to open different doors or combinations of doors in a machine depending on the coded signal it receives. That is, the striker board 6 may control all the functionality for all the locks contained in a single poker machine, on receipt of the correct signals from the controller.

The locks 7,8,9 can be activated one at a time or in combinations as directed by the addressing controller board 3. For example, during trading hours it is desirable to only activate the stacker housing lock 8 if the main door has been opened with a key. During bulk cash clearing of all machines the main door lock 7 and stacker housing lock 8 on every machine may be activated simultaneously.

Furthermore, the central controller may be programmed to only activate certain doors at a predetermined hour or on a predetermined day. For example, the central controller 2 may be arranged to only open the cash box after trading hours.

In one embodiment, the locks 7 and 8 may be a motor rather than another form of mechanical drive actuator. The use of a motor provides more drive power than many other forms of mechanical drive actuators and are therefore suited to be retrofitted to locks that are not designed to be opened by electronic or electrical means.

Each secure area (poker machine) is assigned an identification code, which is programmed into the addressing board 3. For example, poker machine 107 is assigned the ID code 107, poker machine 108 is assigned the ID code 108, etc.

Furthermore, each user of the system is assigned a personal identification (ID) code, which is programmed into the finger scanning unit 1. For example, a first user may be assigned the personal ID code 91. A second user may be assigned the personal ID code 92, etc. In addition to being assigned a personal identification code, each user must also provide a thumb or finger print, which is then scanned, associated with the user's personal identification code and stored as template data in a database contained within the controlling computer 15 and the finger print scanning unit 1.

To gain access to a secure section within a secure area, such as secure section 11 within poker machine 107, a user firstly keys in their personal ID code and the area identification code for the poker machine they wish to access. This is achieved by concatenating the user's personal ID code and the area ID code, and keying the code into the keypad as a single string of digits. For example, if the first user wishes to access poker machine 107, the first user would key the code “91107”. The user then places their finger on the fingerprint scanning unit 1. Once the user's finger is scanned, the fingerprint scanning unit 1 determines if the user has sufficient access rights to the secured area and the secure section.

If the user has sufficient rights to access the secured area, the fingerprint scanner outputs a wiegand data string (the recognised format for transmitting security data). The user's code and the secure area code entered by the user on the keypad form part of the wiegand data string, and the wiegand string is transmitted to the central controller 2. The central controller 2 is capable of interpreting the string, and performs a series of functions once the string is received.

Firstly, the wiegand string is interrogated to extract the secure area and/or section code.

Secondly, this secure area and/or section code is checked to determine which of several types of access is to be granted. For example, a secure area code of 107 would result in a request being sent from the central controller 2 to the striker board 6 located inside the poker machine number 107 to open the stacker door lock 8.

There may also be provided area identification codes which relate to a plurality of areas and thereby allow the release of multiple locks whilst only entering one code. There may be a single area ID code which, when entered, releases all locks 7,8,9, etc. simultaneously, or which releases a sub-set of locks.

For example, a secure area section code “003” would result in a request being sent from the central controller 2 to the striker boards 6 located inside every poker machine in the bank of machines being 105,106,107, etc to open both the stacker door lock 8 and the main door lock 7. Such area codes may be useful for certain purposes, such as cash clearance or maintenance, where a user may need to access a number of secure areas in succession.

If the secure area is located at a distance from the scanner, the central controller may delay the unlocking of the locks 7,8,9 to provide the user with sufficient time to move from the location of the scanner to the secure area.

Initially a user is allocated a personal identification code “91”. This code has a base value of “000” added to indicate an initial enrolment. The user's details are then stored in a database as a single line entry:

| First | Last | Pin | Department | Phone | Template |
|---|---|---|---|---|---|
| John | Smith | 91000 | Admin | 99775522 | (Actual finger |
| | | | | | measurement set) |

When the information is loaded into the database for the first time, the user's initial information (ie the single line entry) is copied for each poker machine and the secure area identifier (PIN) is remembered:

| First | Last | Pin | Department | Phone | Template |
|---|---|---|---|---|---|
| John | Smith | 91105 | Admin | 99775522 | (Actual finger |
| | | | | | measurement set) |
| John | Smith | 91106 | Admin | 99775522 | (Actual finger |
| | | | | | measurement set) |
| John | Smith | 91107 | Admin | 99775522 | (Actual finger |
| | | | | | measurement set) |
| John | Smith | 91108 | Admin | 99775522 | (Actual finger |
| | | | | | measurement set) |
| John | Smith | 91003 | Admin | 99775522 | (Actual finger |
| | | | | | measurement set) |

Thus the user is only required to register and perform a finger scan enrolment once to be able to gain access to a plurality of secure areas (poker machines).

In more detail, the data signals that is transmitted through each stage of the security system is outlined below.

It will be noted that in some embodiments, the data signals are sent at a non standard speed and are not in a TCP/IP format. This preferably enhances security, as it makes it difficult to “spoof” signals in an attempt to gain access to the poker machines.

Once a user enters their ID and is subjected to a fingerscan, the fingerscan unit sends a single Wiegand string to the main controller board, the string containing the user's id code, the ID of the machine or bank to be opened and the data string which represents the user's finger scan data. In turn, the main controller board sends to the addressing board a single encrypted data string containing the user's ID code, the ID code of the machine or bank or lock to be opened and an encryption key to decrypt the string. Once this information is received at the addressing board, the addressing board sends to the striker board, a single encrypted data string containing the lock combination required to open the lock, the delay required and an encryption key to decrypt the string. In some cases, particularly where there is a delay, the addressing board may send a command to ignore the previous open command.

The striker board may also send data signals to the addressing board. This may include a single encrypted data string containing an indication that the machine access door has been opened and an encryption key to decrypt the string.

The addressing board may also communicate with the main controller board, by sending a single encrypted data string containing the machine number that the door lock release has occurred on and an encryption key to decrypt the string.

The addressing board may also communicate with the fingerscan unit by either transmitting a switch signal or a Wiegand signal containing the machine number that was accessed.

The present invention, in at least a specific embodiment, provides a number of advantages. Firstly, it allows a plurality of users to access a plurality of secure areas and/or sections with the use of only one central controller and finger scanner. The embodiment is therefore a cost effective option for applications where, on the one hand, there is a need to restrict access to a large number of areas, but on the other hand, it is not practical or cost effective to fit a single finger scanner to the entrance to each area. An example of such a situation is in a casino or a hotel where there are a large number of poker machines. Due to government legislation and other regulatory controls, access to each poker machine must be strictly monitored, recorded and controlled. In the past, this was achieved by a largely manual system of record keeping and strict control over access to keys or other unlocking devices. Such a system was sub-optimal, because it required a certain degree of trust between the employees and the poker machine operator. In many cases where keys were taken without permission, it was impossible to trace who had accessed a poker machine.

Fitting a biometric scanning device to each poker machine was not a viable option, due to the relative cost of each scanner unit, and the associated cost with programming and updating each unit. In at least a preferred embodiment of the present invention, the computing system for systems administration and record keeping 15 tracks access to each machine and records the access information in a database. This provides a comprehensive audit trail which allows an operator to track who accessed each secure area.

Furthermore, the finger scan 1 may also record the time and date at which the access occurred, or any other pertinent information.

In one embodiment, the computing system for systems administration and record keeping 15 may be arranged to send an alert message to an appropriate authority if access is sought outside established guidelines (for example, if an employee attempts to access a poker machine outside normal working hours).

Secondly, as the user identification and area identification are transmitted as part of the wiegand string, there is no need for separate data channels for transmission of the user ID and the area ID. The complexity of the system is reduced and is also capable of interacting with other industry standard security systems. This makes the system cost effective and capable of “retro fitting” to existing poker machines and existing security systems. Furthermore, poker machines (or other secure areas) may be easily added or subtracted from the system as a whole.

Thirdly, as there is one central point of control, access to every poker machine may be easily controlled by the operator. Users may be added or deleted easily, and as each user is uniquely identified, a full audit trail of each user's activities may be easily maintained.

In the foregoing description, the embodiment of the present invention is described with reference to a plurality of poker machines. It will be understood that other embodiments of the present invention may be used in analogous applications, such as opening one or more of a plurality of doors in a self storage facility, secure areas in a production facility or in any other situation where it is convenient to control a large number of doors or other access means from a central facility.

Furthermore, the present invention contemplates embodiments where it is convenient to control a plurality of any type of device from a central facility. For example, it may be convenient to control access to a large number of personal computers from a central controller (say, for example, in an Internet café or in a University computer laboratory). Such variations and adaptations are encompassed and contemplated by the present invention.

Modifications and variations as would be apparent to a skilled addressee are deemed to be within the scope of the present invention.

1. A security system for controlling access to a plurality of secure areas comprising:
an interface to obtain biometric scan data of a user;
processing means arranged to compare the biometric scan data with stored template data and return a match condition; and
signal means arranged to allow access to at least one of the plurality of secure areas if the match condition is satisfied.

2. A security system in accordance claim 1, wherein each one of the plurality of secure areas corresponds to at least one secure area in each of a plurality of poker machines.

3. A security system for controlling access to at least one secure area in each of a plurality of poker machines comprising:
an interface to obtain verification data of a user;
processing means configured to communicate with the interface and compare the verification data with a stored template to return a match condition; and
signal means arranged to allow access to the at least one secure area in at least one of the plurality of poker machines if the match condition is satisfied.

4. A security system in accordance with claim 3, wherein the verification data comprises biometric scan data.

5. A security system in accordance with either claims 2 to 4, wherein the at least one secure area comprise one of a main door, stacker housing door, belly door, service door and cash box door.

6. A security system in accordance with any one of claims 1, 2 or 4, wherein the biometric scan data is finger scan data.

7. A security system in accordance with any one of the preceding claims, further comprising an interface to allow a user to enter data nominating at least one of the plurality of secure areas and wherein the signal means is arranged to allow access to these nominated secure areas if the match condition is satisfied.

8. A security system in accordance with claim 7, wherein the biometric scan data and the secure area nominating data are transmitted as a single string of data to the processing means.

9. A security system in accordance with claim 8, wherein the single string of data is transmitted in the form of a wiegand string.

10. A security system in accordance with claim 9, wherein the wiegand string is encrypted.

11. A security system in accordance with any one of the preceding claims, wherein the interface is further arranged to allow the user to enter a personal identification code to further identify the user.

12. A security system in accordance with any one of the preceding claims, wherein the processing means is a computing system.

13. A security system in accordance with claim 12, wherein the computing system further includes a database arranged to store template data.

14. A security system in accordance with any one of the preceding claims, wherein, when template data is stored in the database, the personal identification data of the user is replicated and associated with each secure area to create a unique id record for each combination of the user identification data and secure area nomination data.

15. A security system in accordance with claim 14, wherein the processing means further includes logging means arranged to store, in the database, a record of each attempted or successful access to each secured area.

16. A security system in accordance with any one of the preceding claims, wherein the signal means sends a signal via a network to a lock which is arranged to release on receipt of the signal, thereby allowing a user to gain access to the secure area.

17. A security system in accordance with claim 16, wherein the lock is released by actuation of a motor in communication with the lock.

18. A security system in accordance with claim 16 or claim 17, wherein the network further includes a striker board, the striker board being arranged to selectively control at least one of a plurality of locks.

19. A security system in accordance with claim 18, wherein the striker board sends a return signal to the controller to indicate that at least one of the plurality of locks has been released.

20. A security system in accordance with claim 18 or claim 19, wherein the striker board may selectively control a lock on receipt of a plurality of signals.

21. A security system in accordance with any one of claims 16 to 20, wherein the signal means includes a delay means, to vary the time interval that passes before the signal is sent to the lock.

22. A security system in accordance with any one of claims 16 to 21, wherein the processing means includes a time delay means, wherein a lock is only released if the request by a user is made during a predefined time period.

23. A security system in accordance with any one of claims 16 to 22, wherein the processing means includes a cancellation means, wherein a request to release a lock is cancelled if the cancellation means sends a cancellation signal to the lock.

24. A security system in accordance with any one of the preceding claims, wherein the plurality of secure areas includes at least one of a plurality of sections within the internal space of a poker machine.

25. A security system in accordance with any one of the preceding claims, wherein the interface is located remotely of the processing means.
